(19) United States
(12) Patent Application Publication
(10) Pub. No.: US 2012/0179542 A1
(43) Pub. Date: Jul. 12, 2012

(54) Mobile Display System And Method For Delivering Advertising

(76) Inventor: Shawn Patrick Findlan, Darien, CT (US)

(21) Appl. No.: 13/212,828

(22) Filed: Aug. 18, 2011

Related U.S. Application Data
(60) Provisional application No. 61/374,887, filed on Aug. 18, 2010.

(51) Int. Cl. G06Q 30/02

(52) U.S. Cl. 705/14.49

(57) ABSTRACT

Targeted advertisement delivery to a captive audience, with the content limited to a select group of advertisements, and in a way that advertisers can control where, and to whom the advertisements are shown. Advertisements can be delivered via mobile devices which are locked so that interaction is limited to the advertisements. Usage data can be reported back to a server for analysis and distribution to advertisers. Advertisements can be selectively targeted based on demographic, usage, or other information.

### CROSS-REFERENCE TO RELATED APPLICATIONS

The present application claims the benefit under 35 U.S.C. §119(e) of the U.S. Provisional Patent Application Ser. No. 61/374,887, filed on Aug. 18, 2010, the content of which is incorporated herein by reference.

### FIELD OF THE INVENTION

The invention relates to the delivery of targeted advertising, and more specifically to a system and method for delivering targeted video advertising to consumers via handheld mobile devices.

### BACKGROUND OF THE INVENTION

Consumers are increasingly turning to video-on-demand, both on the Internet and via personal digital video recorders (DVR), to view their favorite television shows and movies. More and more consumers are also accessing entertainment and news media on their mobile devices rather than through television. Therefore, traditional advertising methods such as television commercials are becoming less effective.

Other methods of advertising still remain, such as placing fixed advertisements where there are captive audiences. For example, gas pumps are often equipped with static advertisements and in some cases video screens to provide advertisements to consumers while pumping gas. Taxi cabs are likewise equipped with static and video advertisements. However, while the location of such advertisements is known, it is difficult to determine who exactly will view the advertising.

U.S. Patent Application Publication No. 2010/0005489 to Losey discloses a media delivery kiosk deployed at establishments to deliver targeted advertisements to people waiting in the establishment. The media delivery kiosks deliver targeted content based on the location, time of day, and other factors such as weather conditions determined based on the location. However, the media delivery kiosks are not locked to limit the user's interaction to the advertising media and also include games which detract from the focus on the advertisements. Moreover, Losey does not disclose any means for advertisers to control the audience which receives their ads.

It is therefore desired to provide an improved system and method for delivering targeted advertisements to captive audience with the delivered content limited to a select group of advertisements and in a way that the advertisers can control who sees the advertisements and where.

### SUMMARY OF THE INVENTION

The present invention provides a system and method to deliver targeted advertising to captive audiences via a plurality of handheld mobile devices distributed in a number of different locations. While the applications for this system and method are vast, one exemplary use is to deliver advertisements to individuals on chartered business jets.

The mobile devices are loaded with advertising content in the form of high quality video or interactive advertising media. The mobile devices are locked to limit the available content and interaction on the devices to the specified advertising content. The mobile devices are distributed to users according to demographic and/or location preferences specified by the advertisers. In particular, the system includes at least one remote server in communication with a plurality of local servers to which the mobile devices are loaded or synced. Advertising content may therefore be selectively pushed on demand to local servers which satisfy the demographic and/or location preferences.

In the example of chartered business jets, advertisers may choose the charter companies, charter clients, and particular airports to receive their advertisements. Moreover, some embodiments may allow the advertiser to choose by the particular destinations to which the charter business jets are going. Passengers are given a mobile device upon boarding the jet and can view the content during flight.

The mobile devices may also be configured to receive input from users. Users may provide feedback regarding the advertising content, provide identifying information to receive additional information about products or services, and/or may order the advertised products or services via the mobile devices.

The mobile device may also be configured to track usage including, for example, which content is viewed, the date/time, the location(s) (e.g., on which planes, between which cities, etc.), the length of time the content is viewed, and in what order. Usage data may be sent to the remote and/or local server for storage and analysis. For example, the usage data may be analyzed, correlated and reported to advertisers and potential advertisers.

### BRIEF DESCRIPTION OF THE DRAWINGS

FIG. 1 illustrates an exemplary system for delivering targeted advertising according to the present invention.

FIG. 2 illustrates another embodiment of the system shown in FIG. 1.

FIG. 3 illustrates an exemplary method for delivering targeted advertising according to the present invention.

### DETAILED DESCRIPTION OF THE INVENTION

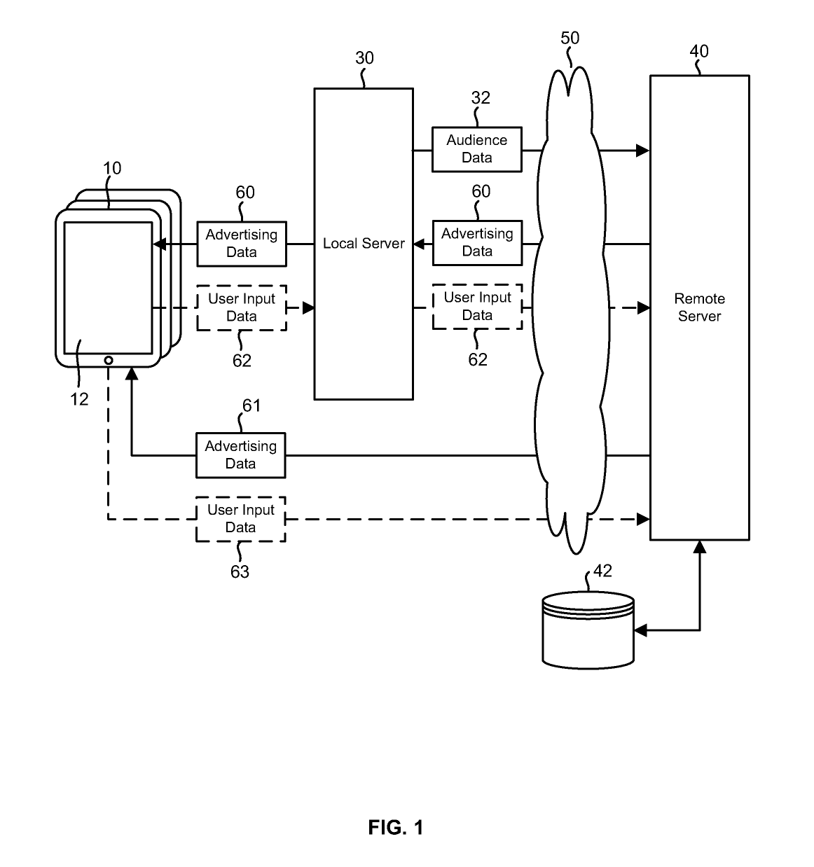

FIG. 1 illustrates an exemplary system for delivering targeted advertising according to the present invention. In the illustrated embodiment, the system includes a plurality of mobile devices 10. The mobile devices 10 include a display 12 and one or more user input mechanisms, such as a touch screen. The mobile devices 10 further include at least one processor or controller (not shown), and one or more software applications executing on the processor or controller.

In a preferred embodiment, the mobile devices 10 are Apple iPads or similar devices. However, the invention is not limited to any particular device. For example, the mobile devices 10 may include iPhones, iPods, Android devices, smart phones, laptops, fixed screed technology and other later developed device types and models.

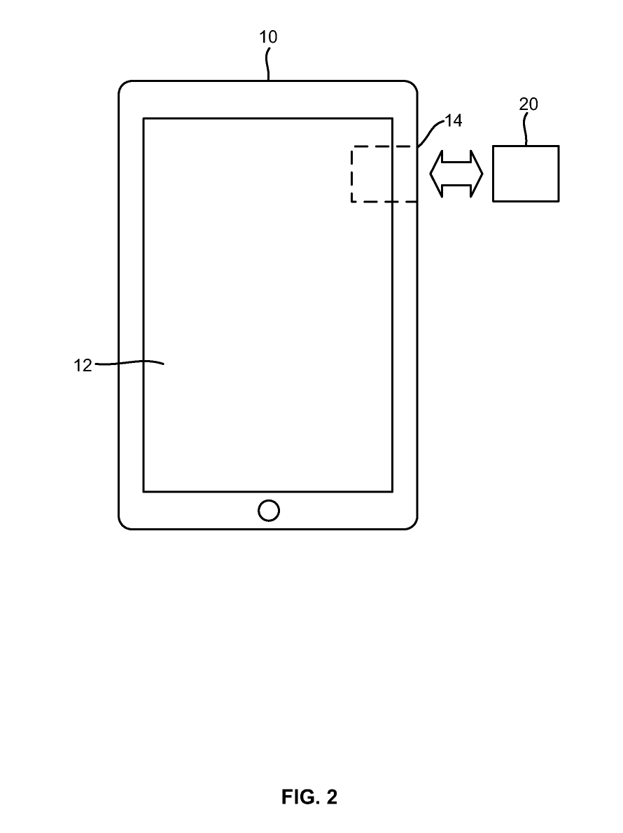

The mobile devices 10 further include or interface with a communication mechanism to receive advertising data to the mobile device 10. The communication mechanism may be, for example, a wired communication port (e.g., USB, FireWire), docking station, or a wireless communication mechanism (e.g., Wi-Fi or cellular transceiver, etc.). In some embodiments, the communication mechanism includes a memory card port 14 for receiving a memory card 20 (see, e.g., FIG. 2).

The mobile devices 10 receive advertising data 60/61 from a local server 30, and/or from a remote server 40 accessible via the Internet 50. In some embodiments, the advertising data 60/61 may also be loaded onto the mobile devices 10 using a memory card 20 (e.g., SD card, CF card, etc.). In a preferred embodiment, the advertising data is stored at the remote server 40 (e.g., in the database 42) and selectively delivered to one or more of the local servers 30 based on audience data 32 received from each local server 30 and advertiser preferences.

The advertising data 60/61 includes one or more advertisements or promotional content items, such as video advertisements or other visual advertising content including as photographs and/ or interactive advertising media. In a preferred embodiment, the advertising data 60/61 is three to five high quality video advertisements which are sent to and stored on the mobile device 10. The mobile devices 10 are preferably locked to limit the available content and interaction on the devices 10 to the specified advertising content. However, the users can select which of the video advertisements to view and in what order by means of the input mechanism (e.g., touch screen). The advertising data 60/61 may further include other content accessible by the users such as text articles, e.g., relating to the advertised products or services.

In some embodiments, the mobile devices 10 may also transmit user input data 62/63 to the local server 30 and/or the remote server 40 using the communication mechanism. For example, users of the mobile devices 10 may provide feedback regarding advertisements viewed on the mobile device 10. Users may further input identifying information to request additional information about a product or service viewed on the mobile device 10 or, in some embodiments, may purchase the product or service via the mobile device 10.

The mobile devices 10 may also transmit usage data 62/63 to the local server 30 and/or the remote server 40. Each mobile device 10 may be configured to track usage including, for example, which content is viewed, the date/time, the location(s) (e.g., on which planes, between which cities, etc.), the length of time the content is viewed, and in what order. In some embodiments, the mobile devices 10 include a usage tracking application executing thereon. The usage data 62/63 is sent to the remote and/or local server (e.g., in real time and/or after a flight) for storage and analysis. For example, the usage data may be analyzed, correlated, and reported from the local or remote servers to advertisers and potential advertisers. In some embodiments, the system may dynamically change content or present new content based on the usage data 62/63.

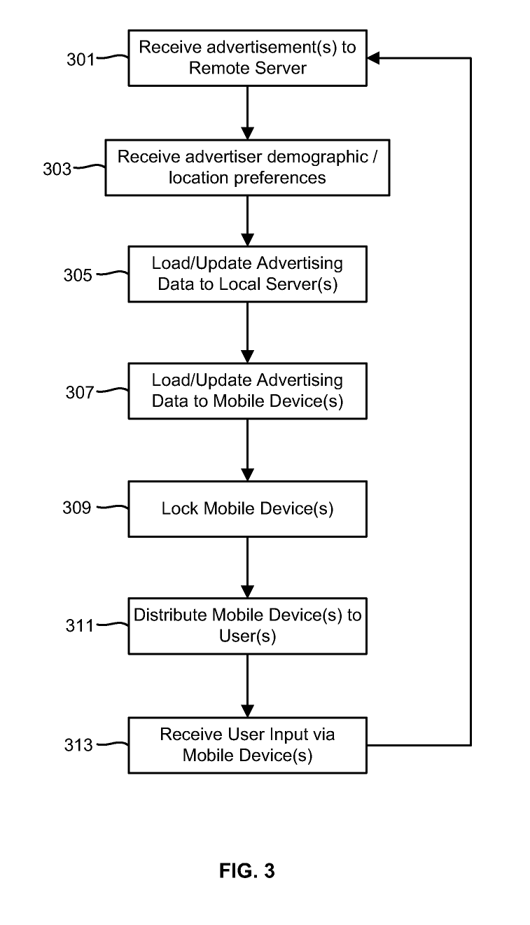

According to the present invention, the mobile devices 10 may be distributed to a seat and/or captive audience, such as to passengers on a charter flight or attendees at a various events such as an auction. As shown in FIG. 3, the remote server receives advertisements from any number of different potential advertisers along with the advertisers' preferences as to the desired audiences for the advertisements (steps 301-303). In particular, advertisers may purchase rights for their advertisements to be provided to individuals. A particular advertiser, upon signing up with the system, may select (e.g., via a web interface) one or more groups of users to which their advertisement will be shown. Advertisers may also select locations or regions of the country or world in which their advertisement will be shown.

The advertisements are sent to the remote server 40 and distributed to a network of local servers 30 and/or directly to mobile devices 10 according the advertisers preferences (step 305-307). For example, a charter jet company may use the system according the present invention and offer the mobile devices 10 to passengers upon boarding a charter flight. The mobile devices 10 are preloaded with advertising content according to the demographic and/or interests of the clientele. In some embodiments, more detailed selections may be made by the advertiser such as particular flight destinations, demographic of the passengers, etc. This and other information about the audience (e.g., audience data 32) may be collected at the local server 30 and sent to the remote server 40 for use in advertiser selections.

The mobile devices are locked to limit the use of the mobile devices 10 to viewing and interacting with the advertising content, and then distributed to the users (steps 309-311). In some embodiments, the system optionally receives user input and/or usage data via the mobile devices during or after use when the mobile devices 10 are collected (step 313).

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for delivering targeted advertising, comprising:
at least one of a local server comprising advertising data and a remote server comprising advertising data;
one or more mobile devices which include a display and a communication mechanism for selectively receiving at least a portion of the advertising data based on advertiser preferences, the portion including one or more video advertisements;
the mobile devices further comprising locking software executing thereon which limits use of the mobile device to viewing or interacting with the portion of advertising data.

2. The system according to claim 1, where the mobile devices include a usage tracking application executing thereon for tracking usage of the mobile device to generate usage data, and for transmitting the usage data to the local or remote server.

3. The system according to claim 2, where the usage data comprises user feedback, user identifying information, product identifying information, time of day, weather conditions, location information, or demographic information.

4. The system according to claim 1, where selectively receiving comprises advertising targeting criteria that include location, time of day, weather conditions, audience identification, audience interests, or demographic information.

5. The system according to claim 1, where the communications mechanism is a wired communication port, docking station, memory card, or wireless communication mechanism.

6. The system according to claim 1, where the advertising data comprises video, still image, interactive, or text advertising media.

7. The system according to claim 1, comprising a plurality of mobile devices, and where the portion includes two or more video advertisements.

8. The system according to claim 1, where the one or more mobile devices are iPads, iPhones, iPods, Android devices, smart phones, or laptop computers.

9. A method for delivering targeted advertising, comprising the steps of:
providing at least one of a local server comprising advertising data and a remote server comprising advertising data;
providing one or more mobile devices which include a display and a communication mechanism;
receiving selectively, by the one or more mobile devices, at least a portion of the advertising data based on advertiser preferences, the portion including one or more video advertisements, and
locking the mobile devices using locking software executing thereon which limits use of the mobile devices to viewing or interacting with the portion of advertising data.

10. The method according to claim 9, further comprising
tracking usage of the mobile devices using usage tracking software executing thereon to generate usage data; and,
transmitting the usage data to the local or remote server.

11. The method according to claim 10, where the usage data comprises user feedback, user identifying information, product identifying information, time of day, weather conditions, location information, or demographic information.

12. The method according to claim 9, further comprising:
targeting the advertising based on location, time of day, weather conditions, audience identification, audience interests, or demographic information.

13. The method according to claim 9, where the communications mechanism is a wired communication port, docking station, memory card, or wireless communication mechanism.

14. The method according to claim 9, where the advertising data comprises video, still image, interactive, or text advertising media.

15. The method according to claim 9, where a plurality of mobile devices are provided, and the portion includes two or more video advertisements.

16. The method according to claim 9, where both a remote server and one or more local servers are provided, and where the remote server pushes advertising data to the one or more local servers based upon demographic or location preferences.

17. The method according to claim 16, where the one or more mobile devices are synced with the one or more local servers.

18. The method according to claim 16, where the one or more mobile devices are synced with the remote server.

19. A system for delivering targeted advertising, comprising:
at least one of a local server comprising advertising data and a remote server comprising advertising data;
a plurality of mobile devices that each include a display, a communication mechanism, locking software executing thereon, and usage tracking software executing thereon;
wherein the communication mechanism is a wired communication port, docking station, memory card, or wireless transmission, and wherein the communication mechanism selectively receives at least a portion of the advertising data based on advertiser preferences, the portion including one or more video advertisements;
wherein the locking software limits use of the mobile device to viewing or interacting with the portion of advertising data;
wherein the usage tracking application tracks usage of the mobile device to generate usage data, the usage data comprising user feedback, user identifying information, product identifying information, time of day, weather conditions, location information, or demographic information, and where the usage data is transmitted to the local or remote server; and
wherein the advertising data comprises video, still image, interactive, or text advertising media, and selectively receiving at least a portion of the advertising data is targeted based on location, time of day, weather conditions, audience identification, audience interests, or demographic information.
